(19) United States
(12) Patent Application Publication
(10) Pub. No.: US 2026/0016792 A1
(43) Pub. Date: Jan. 15, 2026

(54) CONTROLLER CIRCUIT FOR MOTOR

(71) Applicant: ROHM CO., LTD., Kyoto-shi (JP)

(72) Inventor: Tatsuro SHIMIZU, Kyoto-shi (JP)

(21) Appl. No.: 19/336,737

(22) Filed: Sep. 23, 2025

Related U.S. Application Data
(63) Continuation of application No. PCT/JP2024/010830, filed on Mar. 19, 2024.

(30) Foreign Application Priority Data
Mar. 30, 2023 (JP) 2023-056550

(51) Int. Cl. G05B 11/42

(52) U.S. Cl. CPC G05B 11/42

(57) ABSTRACT

The PI compensator generates a manipulated variable based on an error between a detected value of a motor controlled variable and a reference value of the controlled variable. An automatic tuning circuit optimizes the parameters of the PI compensator. An integrator integrates the error. A first coefficient circuit multiplies the output of the integrator by a first coefficient B. An adder adds the output of the first coefficient circuit and the error. A second coefficient circuit multiplies the output of the adder by a second coefficient A. The automatic tuning circuit varies the first coefficient B and adjusts it to a value where the phase difference between the error and the controlled variable becomes 90 degrees.

### CROSS REFERENCE TO RELATED APPLICATIONS

This application is a continuation under 35 U.S.C. § 120 of PCT/JP2024/010830, filed Mar. 19, 2024, which is incorporated herein by reference, and which claimed priority to Japanese Application No. 2023-056550, filed Mar. 30, 2023. The present application likewise claims priority under 35 U.S.C. § 119 to Japanese Application No. 2023-056550, filed Mar. 30, 2023, the entire content of which is also incorporated herein by reference.

### BACKGROUND OF THE INVENTION

### 1. Field of the Invention

The present disclosure relates to a controller circuit for a motor.

### 2. Description of the Related Art

Feedback control utilizing a PI (proportional-integral) compensator is widely employed in motor control. Various methods for setting the coefficients of such compensators have been proposed, including one known as the pole-zero cancellation method. A closed-loop control system designed with the pole-zero cancellation method has a transfer function H(s) between input and output that is equivalent to a first-order step response and is expressed by the following equation:

H(s)=1/(1+sT)

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a PI compensator;

FIG. 2 is a block diagram of a motor drive system including a controller circuit according to an embodiment;

FIG. 3 illustrates automatic tuning of a first coefficient B in the PI compensator of FIG. 2;

FIG. 4 illustrates automatic tuning of a second coefficient A in the PI compensator of FIG. 2;

FIG. 5 is a block diagram of a PI compensator according to one example;

FIG. 6 is a block diagram of a motor drive system according to a first embodiment; and

FIG. 7 is a block diagram of a motor drive system according to a second embodiment.

### DETAILED DESCRIPTION

### Overview of the Embodiment

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A controller circuit for a motor according to one embodiment comprises a proportional-integral (PI) compensator that generates a manipulated variable based on an error between a detected value of a controlled variable of the motor and a reference value of the controlled variable, and an automatic tuning circuit that optimizes a parameter of the PI compensator. The PI compensator comprises an integrator that integrates the error, a first coefficient circuit that multiplies the output of the integrator by a first coefficient, an adder that adds the output of the first coefficient circuit and the error, and a second coefficient circuit that multiplies the output of the adder by a second coefficient. The automatic tuning circuit is structured to vary the first coefficient and to adjust it to a value at which a phase difference between the error and the controlled variable becomes 90 degrees.

In this configuration, the second coefficient does not affect the phase characteristics. Therefore, the phase difference can be optimized by varying the first coefficient, making automatic adjustment easier.

In one embodiment, the transfer function of the control target may be expressed as 1/(τ·s+1), and a reference value of τ is defined as τ₀. In this case, the first coefficient may be defined as 1/(τ₀× α), and the automatic tuning circuit may be configured to vary α based on 1 as a reference.

In one embodiment, the controlled variable may be a current flowing through a coil of the motor.

In one embodiment, the controlled variable may be a rotational speed of the motor.

In one embodiment, a motor controller circuit comprises: a minor controller that controls a minor loop with the current flowing through the motor as the controlled variable; and a major controller that controls a major loop with the rotational speed of the motor as the controlled variable. At least one of the major controller and the minor controller includes a proportional-integral (PI) compensator that generates a manipulated variable based on an error between a detected value of the controlled variable and a reference value of the controlled variable; and an automatic tuning circuit structured to optimize a parameter of the PI compensator. The PI compensator comprises: an integrator structured to integrate the error; a first coefficient circuit structured to multiply an output of the integrator by a first coefficient; an adder structured to add the output of the first coefficient circuit and the error; and a second coefficient circuit structured to multiply an output of the adder by a second coefficient. The automatic tuning circuit is structured to vary the first coefficient and to adjust it to a value at which a phase difference between the error and the controlled variable becomes 90 degrees.

In this configuration, the second coefficient does not affect the phase characteristics. Therefore, by varying the first coefficient, the phase difference can be optimized, making automatic tuning easy.

### EMBODIMENT

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In this specification, a phrase such as “member A is in a state of being connected to member B” includes cases where A and B are physically directly connected, and cases where they are indirectly connected via other members without affecting their connectivity or the functions or effects produced by their connection.

Similarly, a phrase such as “member C is provided between member A and member B” includes cases where C is directly connected to A or B, and cases where C is indirectly connected via other members without affecting electrical connections or the functions or effects produced.

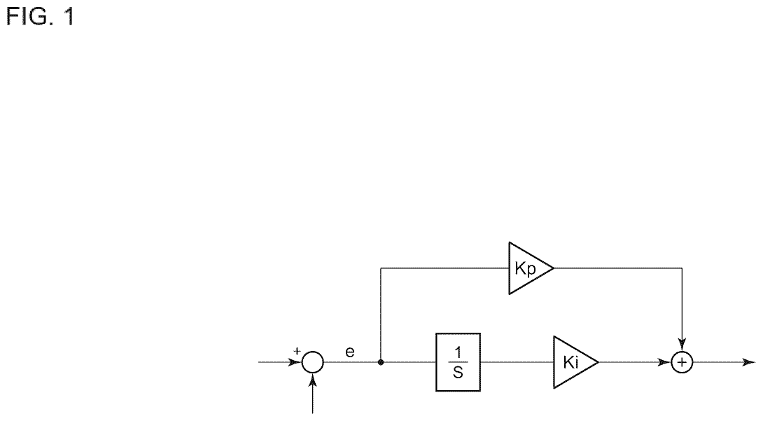

FIG. 1 is a block diagram of a general PI compensator. The PI compensator has proportional gain Kₚ and integral gain Kᵢ as parameters. Its input-output characteristic G(s) is given by G(s)=Kₚ+Kᵢ·1/s. The two coefficients Kₚ and Kᵢ are determined according to the lag element of the plant. In the zero-pole cancellation method, the coefficients Kₚ and Kᵢ are optimized so that the phase difference between input and output becomes 90°.

Because there are a vast number of possible combinations of Kₚ and Kᵢ, implementing an automatic tuning function based on the zero-pole cancellation method had not been easy.

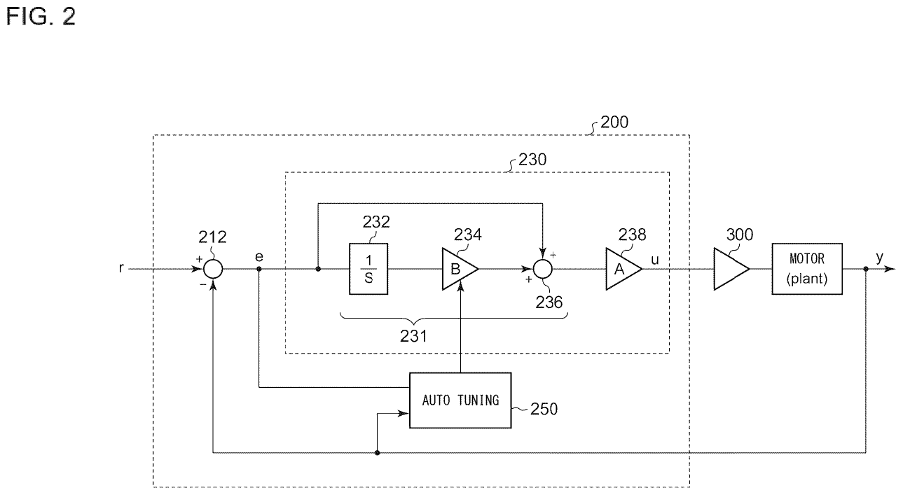

FIG. 2 is a block diagram of a motor drive system 100 including a controller circuit 200 according to an embodiment. The motor drive system 100 comprises a motor 102, the controller circuit 200, and a drive circuit 300.

The motor 102 may be, for example, a three-phase or single-phase DC brushless motor.

The controller circuit 200 performs feedback control of the electrical signal (power, voltage, or current) supplied to the motor 102 so that the motor 102 rotates to a target state. In this motor drive system 100, the controlled variable (system output) y is not particularly limited, and may be the current flowing through the coil of the motor 102 (torque control) or may be the rotational speed of the rotor of the motor 102 (speed control). In the case where the motor 102 is a linear motor, the controlled variable y may be the position of the mover.

The controller circuit 200 generates a manipulated variable u based on an error e between a detected value y of the controlled variable and a reference value r. The controller circuit 200 may be implemented as a combination of a microcontroller (processor) and a software program, as hardware logic such as an Field Programmable Gate Array (FPGA), or as an Application Specific Integrated Circuit (ASIC).

The drive circuit 300 supplies electrical signal to the motor 102 based on the manipulated variable u. That is, if u is a voltage command, the drive circuit 300 supplies a drive voltage based on u to the motor 102. If u is a current command, the drive circuit 300 supplies a drive current based on u to the motor 102.

The controller circuit 200 and the drive circuit 300 may be implemented as separate Integrated Circuits (ICs), or may be integrated into a single IC on the single semiconductor substrate.

The controller circuit 200 includes a feedback circuit 210 and an automatic tuning circuit 250. The feedback circuit 210 includes an error detector 212 and a PI compensator 230. The error detector 212 is a subtractor that calculates an error e between the reference value r and the detected controlled variable y (feedback value). The PI compensator 230 receives the error e and generates the manipulated variable u. Let Kₚ be the proportional gain and Kᵢ be the integral gain. Then, the manipulated variable u is expressed by the following equation:

u=(Kₚ+Kᵢ/s)·e (1)

In the present embodiment, the PI compensator 230 includes an integrator 232, a first coefficient circuit 234, an adder 236, and a second coefficient circuit 238.

The integrator 232 integrates the error e, that is, cumulatively adds it. The integrator 232 is also referred to as an integral element.

The first coefficient circuit 234 multiplies the output of the integrator 232 by a first coefficient B. The adder 236 adds the output of the first coefficient circuit 234 and the error e. The second coefficient circuit 238 multiplies the output of the adder 236 by a second coefficient A.

The input-output characteristic of the PI compensator 230 is given by:

u=(B/s+1)·A·e

={A+AB/s}·e (2)

Comparing equations (1) and (2), A corresponds to the proportional gain Kₚ, and AB corresponds to the integral gain Kᵢ.

The automatic tuning circuit 250 optimizes the parameter B of the PI compensator 230 based on the pole-zero cancellation method. Specifically, the automatic tuning circuit 250 adjusts the first coefficient B by varying its value such that the phase difference between the error e and the controlled variable y becomes 90 degrees.

After the value of the first coefficient B is determined, the value of the second coefficient A is then adjusted. The product of A and the gain of the drive circuit 300 defines the cutoff frequency of the overall system.

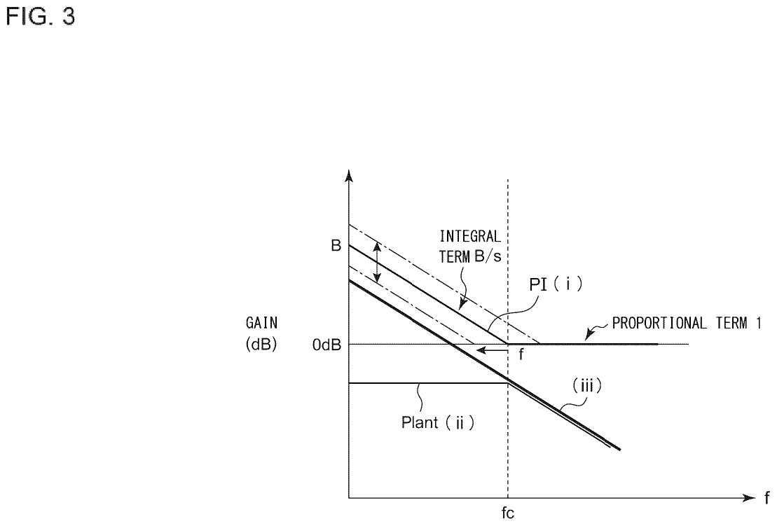

FIG. 3 is a diagram illustrating the automatic tuning of the first coefficient B in the PI compensator 230 shown in FIG. 2. In FIG. 3, line (i) shows the gain characteristics of section 231, which includes the integrator 232, the first coefficient circuit 234, and the adder 236. The transfer function of this section is (B/s+1), where B/s is the integral term and 1 is the proportional term. When the first coefficient B is varied, the integral term B/s shifts up or down. In other words, the frequency f at which it intersects the proportional term (gain of 0 dB) changes.

In FIG. 3, line (ii) shows the gain characteristics of the controlled object (plant). The controlled object is a first-order lag element having a transfer function of 1/(t's+1), and exhibits the gain characteristics of a low-pass filter with a cutoff frequency f_{c} determined by the time constant t.

Through tuning by the automatic tuning circuit 250 using the pole-zero cancellation method, the first coefficient B is optimized such that the frequency f, which is the intersection point of the integral term B/s and the proportional term 1, matches the cutoff frequency f_{c} of the controlled object, which is the low-pass filter.

Once the first coefficient B is optimized, the gain characteristics of the overall system, which includes the controlled object and the PI compensator, exhibit an integral characteristic, as shown as line (iii).

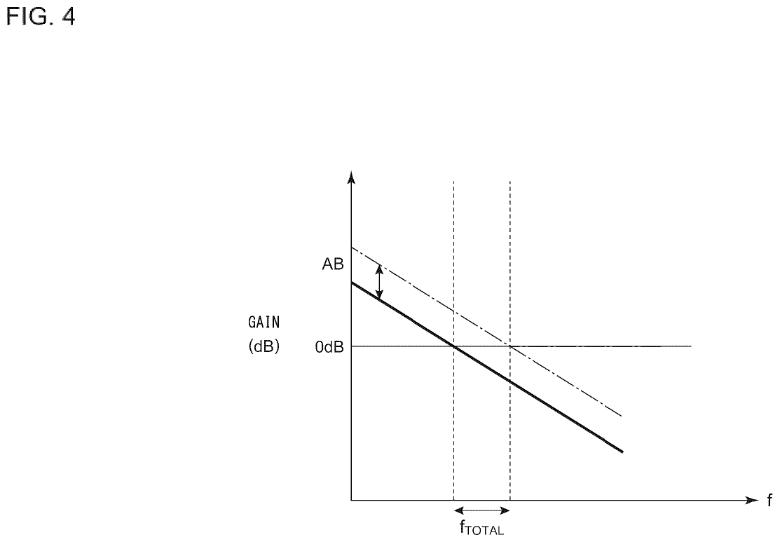

FIG. 4 is a diagram illustrating the tuning of the second coefficient A in the PI compensator 230 shown in FIG. 2. When the second coefficient A is varied, the gain characteristics of the overall system shift upward or downward while maintaining the integral characteristic. As a result, the cutoff frequency f_{TOTAL} of the overall system gain characteristics can be adjusted.

The above describes the operation of the controller circuit 200.

The advantages will now be described. In the PI compensator shown in FIG. 1, when the proportional gain Kᵢ is changed, the integral gain Kₚ, which provides a 90-degree phase shift, also changes. Therefore, if the integral gain Kₚ is first optimized so that the phase difference between input and output becomes 90 degrees, and then the proportional gain Kᵢ is modified, the frequency characteristics of the overall system deviate from those of an ideal integrator. As a result, the integral gain Kₚ must be readjusted. In other words, it is difficult to optimize both parameters simultaneously.

In contrast, in the configuration of the PI compensator 230 shown in FIG. 2, the second coefficient A does not affect the phase characteristics. Therefore, even if the second coefficient B is varied after the first coefficient A has been optimized so that the phase difference between input and output becomes 90 degrees, the integral characteristic of the overall system is maintained. As a result, there is no need to readjust the first coefficient A.

As described above, according to the controller circuit 200 of the present embodiment, accurate automatic tuning can be achieved.

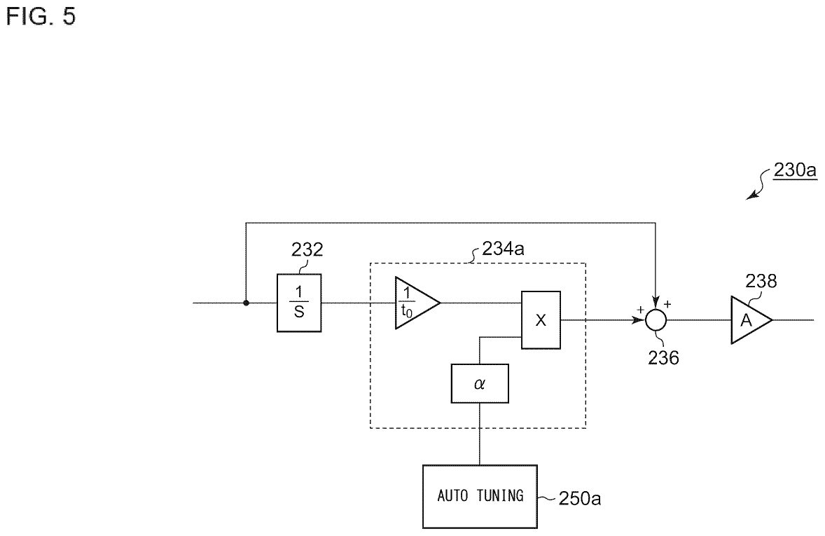

FIG. 5 is a block diagram of a PI compensator 230a according to an embodiment. As described above, the controlled object, which is a motor, is a first-order lag element, and its transfer function is expressed as:

1/(τs+1)

where τ is the time constant.

In the PI compensator 230a having the configuration shown in FIG. 2, the phase difference between input and output becomes 90 degrees when the second coefficient B is equal to 1/τ. Here, a reference value to is defined with respect to the time constant t of the controlled object. This reference value to may be determined, for example, as the average of the time constants of several types of motors assumed to be used as the controlled object.

The first coefficient B of the first coefficient circuit 234a in the PI compensator 230a is expressed as B=(1/τ₀)×α. In other words, the first coefficient B is obtained by multiplying the reference time constant to by a correction coefficient a. The automatic tuning circuit 250a adjusts the correction coefficient a by varying it around the reference value of 1, such that the phase difference between input and output becomes 90 degrees.

The present disclosure encompasses various devices and methods that can be understood from the block diagram and circuit diagram of FIG. 2, or derived from the above description, and is not limited to any specific configuration. The following descriptions of more specific configuration examples and embodiments are provided not to limit the scope of the present disclosure, but rather to aid in understanding the essence and operation of the disclosure and the invention, and to clarify them.

### Embodiment 1

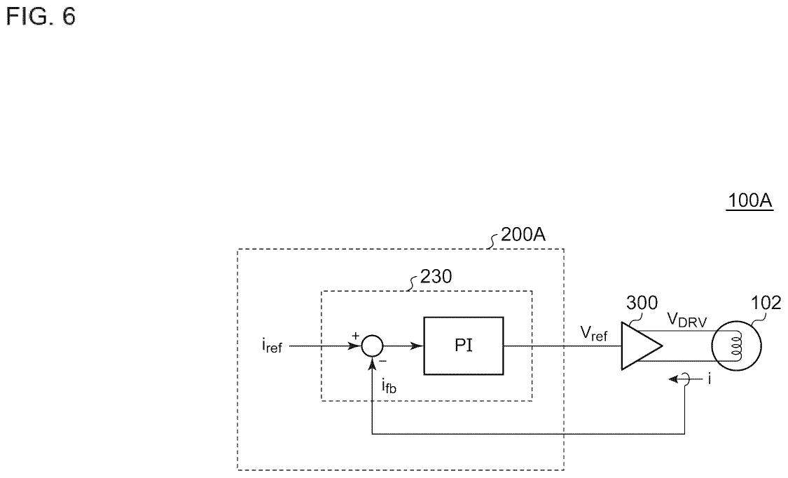

FIG. 6 is a block diagram of a motor drive system 100A according to Embodiment 1. In this embodiment, the motor drive system 100A controls the current i flowing through the coil of the motor 102 (coil current) as the controlled variable.

The controller circuit 200 generates a voltage command V_{ref} that specifies the drive voltage V_{drv} to be applied to the motor 102, such that the error between the reference value i_{ref} of the coil current and the detected value in of the coil current approaches zero.

The drive circuit 300 applies a drive voltage V_{drv} to the motor 102 in proportion to the voltage command V_{ref}. The drive method of the drive circuit 300 is not particularly limited. In the case of a PWM (pulse-width modulation) drive method, the drive circuit 300A may include a pulse-width modulator and an inverter. In that case, the duty cycle of the pulse signal generated by the pulse-width modulator is adjusted according to the voltage command V_{ref}.

In the case of a linear drive method, the drive circuit 300A may include a linear amplifier that amplifies the voltage command V_{ref} and generates the drive voltage V_{drv}.

The configuration of the controller circuit 200A is the same as that described with reference to FIG. 2, and therefore its explanation is omitted.

### Embodiment 2

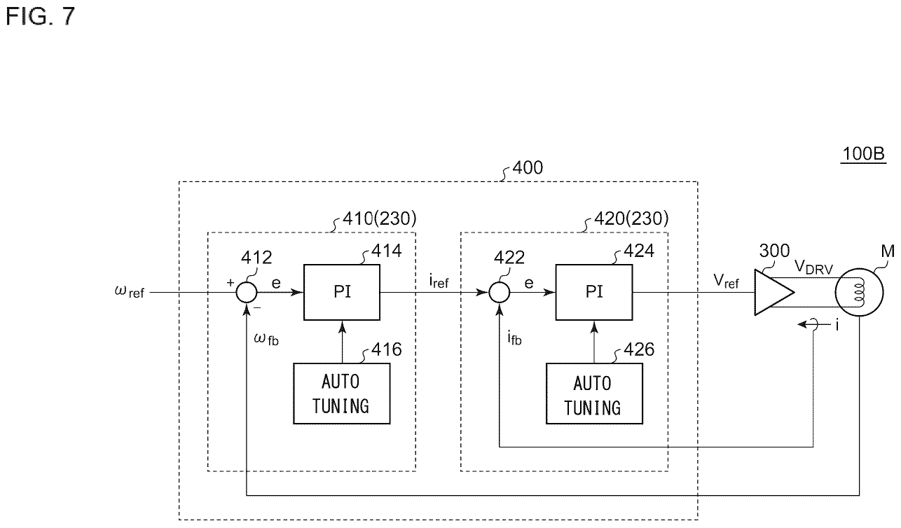

FIG. 7 is a block diagram of a motor drive system 100B according to Embodiment 2. The motor drive system 100B includes a motor 102, a drive circuit 300, and a controller circuit 400. The controller circuit 400 comprises a major controller 410 and a minor controller 420.

The major controller 410 performs feedback control with the rotational speed ω of the motor 102 as the controlled variable. The major controller 410 receives the command value ω_{ref} and the detected value of ω_{fb} the rotational speed, and generates a current command i_{ref} (torque command) such that the error e between the command value and the detected value approaches zero. The major controller 410 may include an error detector 412 and a PI compensator 414.

The minor controller 420 performs feedback control with the coil current i of the motor 102 as the controlled variable. The minor controller 420 generates a voltage command V_{ref} such that the error between the command value i_{ref} of the coil current and the detected value i_{fb} of the coil current approaches zero. The minor controller 420 may include an error detector 422 and a PI compensator 424.

The PI compensators 414 and 424 of the major controller 410 and the minor controller 420, respectively, have the configuration shown in FIG. 2, and are configured such that their parameters can be automatically adjusted by the automatic tuning circuits 416 and 426. It is also acceptable to adopt the architecture of FIG. 2 in only one of the major controller 410 or the minor controller 420.

The embodiments are presented by way of example, and it will be understood by those skilled in the art that various modifications may be made to the combinations of the constituent elements and processing steps. Such modifications are also included within the scope of the present disclosure or the present invention.

### Additional Note

The technology disclosed in the present specification can be understood, in one aspect, as described below.

### Item 1

A controller circuit for a motor, comprising:
a proportional-integral (PI) compensator structured to generate a manipulated variable based on an error between a detected value of a controlled variable of the motor and a reference value of the controlled variable; and
an automatic tuning circuit structured to optimize a parameter of the PI compensator,
wherein the PI compensator includes:
an integrator structured to integrate the error;
a first coefficient circuit structured to multiply an output of the integrator by a first coefficient;
an adder structured to add the output of the first coefficient circuit and the error; and
a second coefficient circuit structured to multiply an output of the adder by a second coefficient,
wherein the automatic tuning circuit is structured to vary the first coefficient and to adjust it to a value at which a phase difference between the error and the controlled variable becomes 90 degrees.

### Item 2

The controller circuit according to Item 1, wherein a transfer function of a control target is expressed as 1/(τ·s+1), and wherein when a reference value of τ is defined as τ₀, the first coefficient is defined as 1/(τ₀× α); and
wherein the automatic tuning circuit is structured to vary α with 1 as a reference.

### Item 3

The controller circuit according to Item 1 or 2, wherein the controlled variable is a current flowing through a coil of the motor.

### Item 4

The controller circuit according to Item 1 or 2, wherein the controlled variable is a rotational speed of the motor.

### Item 5

The controller circuit according to Item 1 or 2, wherein the controlled variable is a position of the motor.

### Item 6

A controller circuit for a motor, comprising:
a minor controller structured to control a minor loop with a current flowing through the motor as a controlled variable;
a major controller structured to control a major loop with a rotational speed of the motor as a controlled variable;
wherein at least one of the major controller and the minor controller comprises:
a proportional-integral (PI) compensator structured to generate a manipulated variable based on an error between a detected value of a controlled variable of the motor and a reference value of the controlled variable; and
an automatic tuning circuit structured to optimize a parameter of the PI compensator;
wherein the PI compensator comprises:
an integrator structured to integrate the error;
a first coefficient circuit structured to multiply an output of the integrator by a first coefficient;
an adder structured to add the output of the first coefficient circuit and the error; and
a second coefficient circuit structured to multiply an output of the adder by a second coefficient,
wherein the automatic tuning circuit is structured to vary the first coefficient and to adjust it to a value at which a phase difference between the error and the controlled variable becomes 90 degrees.

What is claimed is:

1. A controller circuit for a motor, comprising:
a proportional-integral (PI) compensator structured to generate a manipulated variable based on an error between a detected value of a controlled variable of the motor and a reference value of the controlled variable; and
an automatic tuning circuit structured to optimize a parameter of the PI compensator,
wherein the PI compensator includes:
an integrator structured to integrate the error;
a first coefficient circuit structured to multiply an output of the integrator by a first coefficient;
an adder structured to add the output of the first coefficient circuit and the error; and
a second coefficient circuit structured to multiply an output of the adder by a second coefficient;
wherein the automatic tuning circuit is structured to vary the first coefficient and to adjust it to a value at which a phase difference between the error and the controlled variable becomes 90 degrees.

2. The controller circuit according to claim 1, wherein a transfer function of a control target is expressed as 1/(τ·s+1), and wherein when a reference value of τ is defined as τ₀, the first coefficient is defined as 1/(τ₀×α); and
wherein the automatic tuning circuit is structured to vary α with 1 as a reference.

3. The controller circuit according to claim 1, wherein the controlled variable is a current flowing through a coil of the motor.

4. The controller circuit according to claim 1, wherein the controlled variable is a rotational speed of the motor.

5. The controller circuit according to claim 1, wherein the controlled variable is a position of the motor.

6. A controller circuit for a motor, comprising:
a minor controller structured to control a minor loop with a current flowing through the motor as a controlled variable;
a major controller structured to control a major loop with a rotational speed of the motor as a controlled variable;
wherein at least one of the major controller and the minor controller comprises:
a proportional-integral (PI) compensator structured to generate a manipulated variable based on an error between a detected value of a controlled variable of the motor and a reference value of the controlled variable; and
an automatic tuning circuit structured to optimize a parameter of the PI compensator;
wherein the PI compensator comprises:
an integrator structured to integrate the error;
a first coefficient circuit structured to multiply an output of the integrator by a first coefficient;
an adder structured to add the output of the first coefficient circuit and the error; and
a second coefficient circuit structured to multiply an output of the adder by a second coefficient,
wherein the automatic tuning circuit is structured to vary the first coefficient and to adjust it to a value at which a phase difference between the error and the controlled variable becomes 90 degrees.
